(19) United States
(12) Patent Application Publication
(10) Pub. No.: US 2002/0081562 A1
(43) Pub. Date: Jun. 27, 2002

(54) Home tutoring system utilizing internet and a private tutor

(76) Inventor: Takeshi Uemura, Soka-City (JP)

Correspondence Address: Takeshi Uemura, 2-18-32, TAKASAGO, SOKA-CITY, SAITAMA-PREF., 340-0015, JP

(21) Appl. No.: 09/749,087

(22) Filed: Dec. 25, 2000

(51) Int. Cl. G09B 3/00

(52) U.S. Cl. 434/350

(57) ABSTRACT

Students have to attend a cram school or employ a private tutor to help their studying to enter the school of their wishes. As schools with many applicants are very competitive, they have to study efficiently. This tutoring system is offered for the above purpose.

This is a system in which Tutor Service Headquarters (referred to as “Headquarters” hereafter), a private tutor (referred to as “tutor” hereafter, a student and the guardian of the student (referred to as “guardian” hereafter) exchange the information and data through Internet and direct interviews for more effective study of the student in studying method by utilizing a private tutor.

### BACKGROUND OF THE INVENTION

The present invention is concerning home tutoring system by utilizing Internet and a private tutor to support a student to study for the entrance exam of the school of a higher grade or for the knowledge of new study.

Conventionally, Tutors have been a part-time job of university students or sent by employment agencies.

Conventional technology has had the following faults:

a. Tutors' ability is not equal.

b. The contents of tutoring cannot be evaluated by the third person.

c. The content of tutoring tends to be monotonous, which leads to less efficiency.

d. The income of tutors is low.

e. The relationship with the students or guardian is difficult because the personality of tutors cannot be judged.

### SUMMARY OF THE INVENTION

This is a system in which Tutor Service Headquarters (referred to as “Headquarters” hereafter), a private tutor (referred to as “tutor” hereafter), a student and the guardian of the student (referred to as “guardian” hereafter) exchange the information and data through Internet and direct interviews for more effective study of the student in studying method by utilizing a private tutor.

Headquarters make a database based on all data regarding the tutor when entering into a contract with him/her. Also, the tutor clearly notifies his/her educational policy, his/her outstanding subjects, desired salary, working hours, his/her strong and weak points, work period, etc. when he/she makes a contract with Headquarters. Guardian who seeks a tutor for the student accesses to the homepage of Headquarters on Web site of Internet for the application. When applying this system, guardian inputs the data regarding the student in the columns of the homepage and also his/her requests for the tutor at the same time (for example, male or female, age, outstanding subject, personality, social experience etc). After contracting with the student and guardian, Headquarters send a tutor. First, tutor, student and guardian meet to talk about the details of tutoring. Then, it is confirmed that tutoring is proceeded based on the study curriculum of Headquarters. After tutoring started, the tutor regularly reports the progress and the evaluation of the study to Headquarters directly or through the terminal unit of Internet. At the same time, the same information is also provided to guardian. Guardian can contact to Headquarters to check the progress of the study at any time. Furthermore, guardian can access to the homepage of Headquarters that has been prepared beforehand by utilizing a keyword through the terminal unit of Internet to input his/her requests or complaints if any. Tutor who has obtained a high evaluation from guardian receives the bonus point from Headquarters. The student also receives the bonus point from the tutor according to the progress of the study and is awarded a prize later. This is a home tutoring system by utilizing Internet and tutor which features to create an educational environment for the student to study most willingly and effectively by the cooperation of the student, guardian and tutor to achieve the goal within a certain period and to construct the system for students to study willingly and join the volunteer activities actively including an education to develop good points of students or a method to encourage students to help the housework positively with praise etc.

### DETAILED DESCRIPTION OF THE INVENTION

The following explains the form to execute this invention:

A. Tutor Service Headquarters (referred to as “Headquarters” hereafter) establish a main server in the Internet and open the homepage.

B. Headquarters invite tutors (referred to as “tutor” hereafter) from various fields such as businessmen, university professors, university students, researchers, professional engineers, etc. utilizing the advertisement of media and Internet

C. Headquarters make contract with tutors. The terms of the contract are uniform at first, but vary depending on tutor's ability later. Especially, salary varies among tutors.

D. Headquarters make the database of the contract tutor including age, sex, and teaching experience, outstanding subjects, physical characteristics, personality, family background, and career, etc.

E. Headquarters offer the training of the teaching method to Tutors for a certain period. Basically, the training is programmed to match Tutors' ability.

F. Headquarters input the entrance exams of all universities, high schools, junior high schools, and vocational schools as a database. Any one can access this database by utilizing the keyword.

G. Necessary materials including the contents of the study, the teaching program, the evaluation of the study, etc. are input in a database. Tutors access to the data through the terminal unit of Internet or Cellular phone applicable to Web, by utilizing the keyword at any time and from any places.

H. Applicants, that is a student and guardian of the student (referred to as “guardian” hereafter) who seek a tutor access to the homepage of Headquarters through the terminal unit of Internet or Cellular phone applicable to Web.

I. The applicants input tutoring frequency and period, study contents, tutor type and school they wish to enter in the columns of tutoring application in Homepage of Headquarters.

J. Headquarters select a tutor from the database according to the contents of the application. Appointed tutor contacts the student and guardian for an interview.

K. After an interview, the student and guardian report the evaluation of the tutor by ‘yes’ or ‘No’ to Headquarters. If the evaluation is ‘yes’, Headquarters send the tutor to the student. If it is ‘no,’ Headquarters select the next candidate from the database again, thus repeating this procedure until having the student and guardian satisfied.

L. Tutor approved by the student and guardian has a consultation with the student and guardian and starts studying.

M. Tutor reports the details and the progress of the study to Headquarters and guardian directly or through the terminal unit of Internet.

N. Guardian contacts the tutor and Headquarters directly or through Internet for requests or desires about tutoring if any. The homepage of Headquarters prepares the column for the requests and desires from students and guardians.

O. Tutor reports the evaluation of the student to guardian and Headquarters after having offered tutoring service for a certain period. For example, the tutor sends review tests and answers of the assignment of the student to Headquarters. The student who has achieved the goal that was set at the beginning of tutoring is provided with bonus points and awarded a prize afterward.

P. The present system includes a reward for the tutor who has obtained a high evaluation from the student and guardian.

Q. Headquarters construct a tutoring system to expire students to study willingly and most effectively and select the best tutor so that students can enter the school of their wishes.

In addition, the present system can be applied to the home nursing system.

Headquarters keep the tutors of high level in tutoring. It means tutoring service by the tutor of a high quality is provided to students even if student and guardian select the tutor freely. This system helps students to study willingly and effectively, which enables them to easily pass the entrance exam of the school of their wishes.

The present system includes the reward for Tutors according to their performance and ability. Efficient operation of the present system leads Headquarters to a profitable business due to the high evaluation from guardian and student.

What is claimed is:

1. This is a system in which Tutor Service Headquarters (referred as to “Headquarters” hereafter), a private tutor (referred to as “tutor” hereafter), a student and the guardian of the student (referred as to “guardian” hereafter) exchange the information and data through Internet and direct interviews for more effective study of the student in studying method by utilizing a private tutor.
Headquarters make a database based on all data regarding the tutor when entering into a contract with him/her. Also, the tutor clearly notifies his/her educational policy, his/her outstanding subjects, desired salary, working hours, his/her strong and weak points, work period, etc. when he/she makes a contract with Headquarters. Guardian who seeks a tutor for the student accesses to the homepage of Headquarters on Web site of Internet for the application. When applying this system, guardian inputs the data regarding the student in the columns of the homepage and also his/her requests for the tutor at the same time (for example, male or female, age, outstanding subject, personality, social experience etc). After contracting with the student and guardian, Headquarters send a tutor. First, tutor, student and guardian meet to talk about the details of tutoring. Then, it is confirmed that tutoring is proceeded based on the study curriculum of Headquarters. After tutoring started, the tutor regularly reports the progress and the evaluation of the study to Headquarters directly or through the terminal unit of Internet. At the same time, the same information is also provided to guardian. Guardian can contact to Headquarters to check the progress of the study at any time. Furthermore, guardian can access to the homepage of Headquarters that has been prepared beforehand by utilizing a keyword through the terminal unit of Internet to input his/her requests or complaints if any. Tutor who has obtained a high evaluation from guardian receives the bonus point from Headquarters. The student also receives the bonus point from the tutor according to the progress of the study and is awarded a prize later. This is a home tutoring system by utilizing Internet and tutor, which features to create an educational environment for the student to study most willingly and effectively by the cooperation of the student, guardian and tutor to achieve the goal within a certain period and to construct the system for students to study willingly and join the volunteer activities actively including an education to develop good points of students or a method to encourage students to help the housework positively with praise etc.
